(19) United States
(12) Patent Application Publication
(10) Pub. No.: US 2016/0186965 A1
(43) Pub. Date: Jun. 30, 2016

(54) FACE ILLUMINATION MEANS

(71) Applicant: Jim BURNS, Grand Rapids, MI (US)

(72) Inventor: Jim Burns, Grand Rapids, MI (US)

(21) Appl. No.: 14/910,686

(22) PCT Filed: Jul. 16, 2014
(86) PCT No.: PCT/US14/46795

§ 371 Date: Feb. 6, 2016

Related U.S. Application Data
(60) Provisional application No. 61/862,546, filed on Aug. 6, 2013.

(51) Int. Cl. F21V 21/08; F21L 4/04; F21V 21/32

(52) U.S. Cl. CPC F21V 21/08; F21V 21/32; F21L 4/04; F21L 2001/00

(57) ABSTRACT

The present invention is directed to a light source controlled by the user that can direct light rays toward the face of the user.

### RELATED APPLICATION

This application claims priority from a provisional patent application No. 61/862,546.

### GOVERNMENT RIGHTS

This invention was not made with Government support. The Government does not have any rights in this invention.

### FIELD OF THE INVENTION

This invention relates to a hands-free apparatus and method to illuminate a face from a light source that does not illuminate much other space, and can be controlled by the user as to when to turn the light on.

### BACKGROUND OF THE INVENTION

Currently when one is touring a themed “haunted house,” usually during Halloween time, the actors who are supposed to scare the patrons, will usually have to step out from a darkened corner, and walk into a light beam. The light beam is usually on the ceiling, and the light beam projects downwardly.

This provides the disadvantage that the light is usually on when there is no one in the line of the beam that is on from the ceiling.

Another disadvantage is that the light is stationary, and the actor has to move from a non-visible location, into the zone of light illumination.

What is needed is a mobile light source that can be disposed underneath the clothing when needed, and can illuminate the face of the user.

There is also need of a mobile light source that can be turned on and off by the user.

There is also need of a mobile light source that can be dimmed for brightness control, and has adjustable distance with respect to its position from the face of the user.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the present invention is a face illumination means 10, comprising: a light tube 40 that secured to at least one of either the body or clothing of a user; a light source 20 operably disposed in said light tube 40 so that the user can direct light rays 130 that emanate from said light source 20 toward the face of the user.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of one embodiment of the present invention;

FIG. 3 is a pictorial view of another embodiment with a resistor;

FIG. 4 is a pictorial view of of an embodiment showing a front view;

FIG. 5 is a pictorial view of an embodiment showing a rear view;

FIG. 6 is a pictorial view of an embodiment showing the light tube;

FIG. 7 is a pictorial view of an embodiment showing a stethoscope mounting style;

FIG. 8 is a pictorial view of another embodiment; and

FIG. 9 is a pictorial of an embodiment with a wireless controller.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

### REFERENCE NUMERALS LIST

10 face illumination means
20 light source
30 neck attachment
40 light tube
50 cord
60 controller
70 on-off control
80 flickering light control
90 dimmer control
100 color control
110 sound control
120 clasp
130 light rays
140 power source
150 speaker
160 resistor
170 vertical angle of light
180 width angle of light
190 stethoscope mounting embodiment

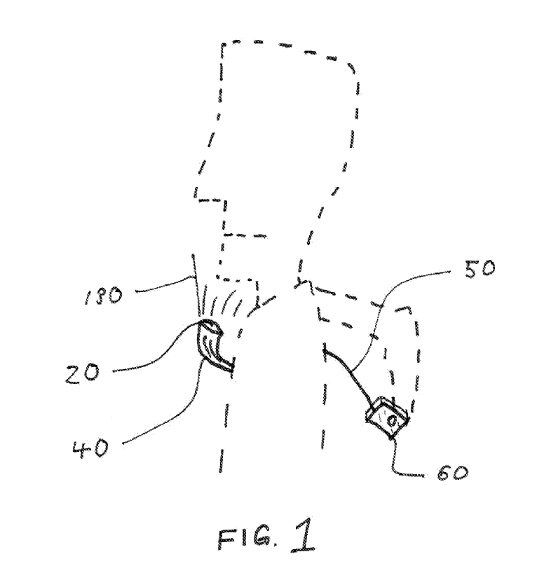

FIG. 1 illustrates one embodiment of the present invention 10, which may be referred to as a face illumination means 10. The face illumination means 10 may hang about the neck of the user via an attachment means 30. In one embodiment the light source 20 is connected to a wire necklace, also referred to as a neck attachment 30. A light tube 40 may extend from the neck attachment 30. The light tube 40 may have a light source 20 therein to shine light in a desired direction.

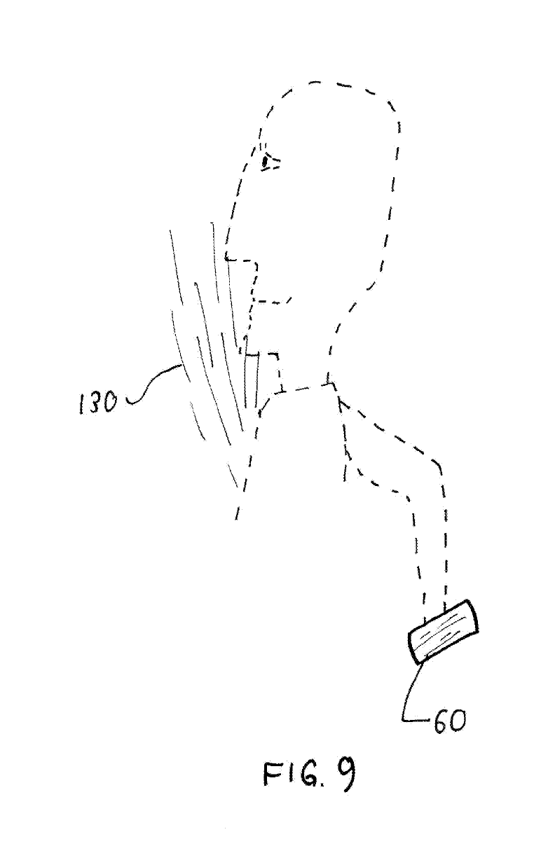

A controller 60 may be operably disposed to the light source 20 so as to control features of the light source 20. The controller 60 may be wirelessly connected (as seen in FIG. 9), or connected by cord 50 to the light source 20.

The light source 20 may disperse light rays 130 on the user's face.

The controller 60 may house a power source 140, such as 2 AA batteries, or another suitable source. In one embodiment a 3 volt power source 140 was suitable. In another embodiment rechargeable batteries are suitable.

The light source 20 may be a light bulb, such as an LED. It has been determined that one suitable LED is a 5 mm LED.

The light tube 40 may be bendable and able to be placed in a fixed position so that the light source 20 can be directed and pointed in different directions to shine light rays 130 at the user's face.

FIG. 1 illustrates the controller 60 in the right hand of the user.

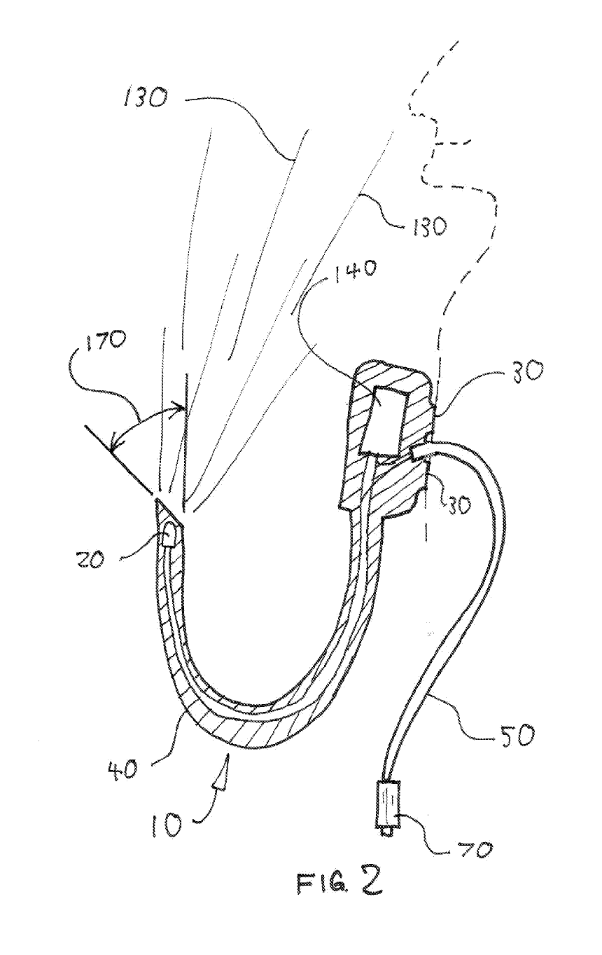

FIG. 2 illustrates another embodiment where the face illumination means 10 has a power source 140 that is removably attached to the chest area of the user via an attachment means 30. In this embodiment the attachment means 30 may include but not be limited to safety pins, badge or pin clips, or magnets 30.

The light tube 40 may be adjustable and may stay in the position directed, so the user can point the light rays 130 in different directions. One type of tubing that would be appropriate for the light tube 40 may be an adjustable tubing found at http://www.flexible-tubing.com/PT%20Superflex.htm as of 26 Feb. 2014. A vertical angle of light 170 may be defined by the angle of a truncated end-portion of the light tube 40. The angle in one embodiment may be about 45 degrees to allow for an adequate direction and amount of light ray 130 distribution.

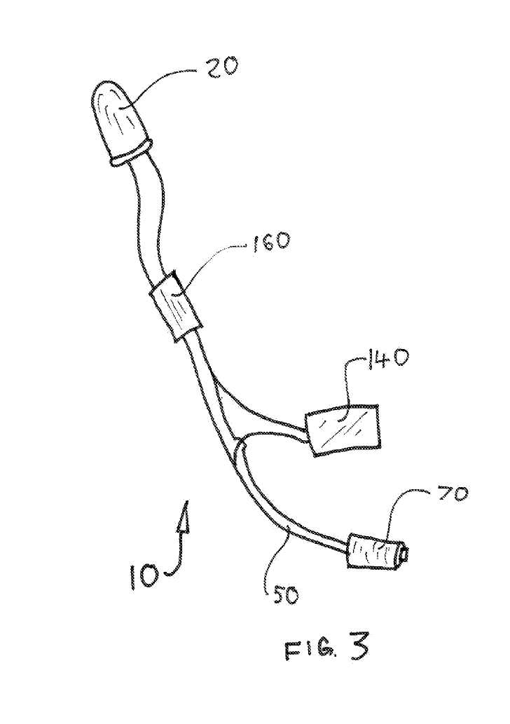

FIG. 3 illustrates an embodiment of the present invention 10 with the use of an appropriate rated resistor 160 operably disposed between the light source 20 and the power source 140.

The cord 50 may be bonded wire, and may be similar to that of a lamp cord to 24 gauge.

In one embodiment, for face illumination means with one LED, the power source 140 may be two (2) AA batteries, or one CR2032 coit battery. In another embodiment, if the light source 20 comprises multiple LEDs, then a 9 volt battery may be appropriate.

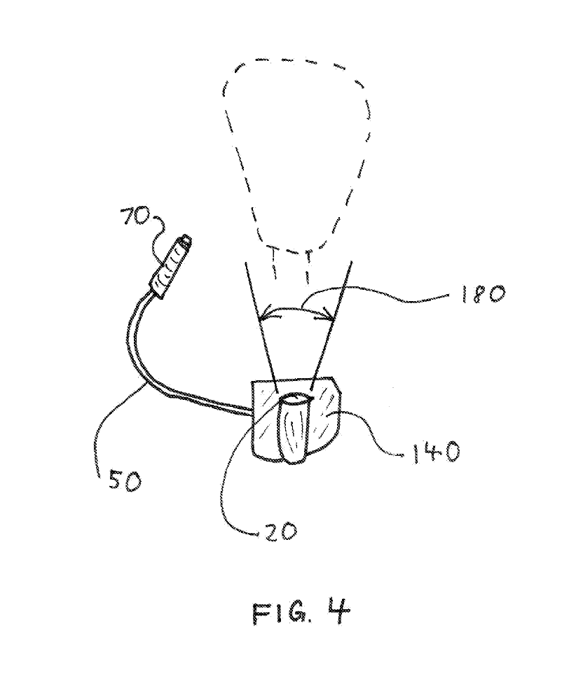

FIG. 4 illustrates an embodiment showing a width angle of light 180. Here, the light source 20 may be disposed inside a light tube 40 that is adjustable and can stay fixed in a desired position.

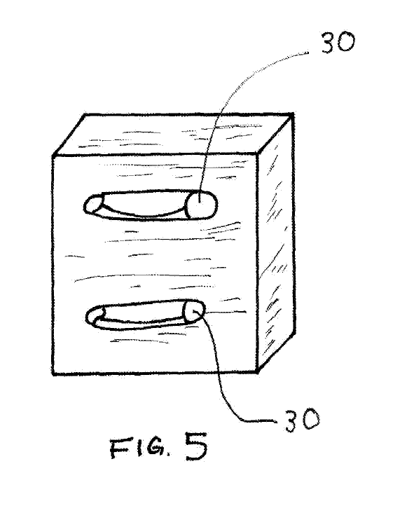

FIG. 5 illustrates an embodiment of a rear view of the power source 140. This illustrates that the attachment means 30 may be a safety pin, badge or nameplate pin, or magnets to connect the power source 140 to clothing or a costume.

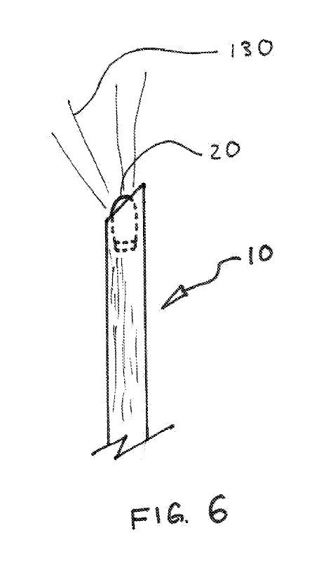

FIG. 6 illustrates an embodiment showing the light source 20 may be positioned slightly outside of the truncated or tapered portion of the light tube 40. For a single LED application, the type of LED being used may be one that can fit inside a light tube 40 that has an inside diameter of about 3 mm-5 mm.

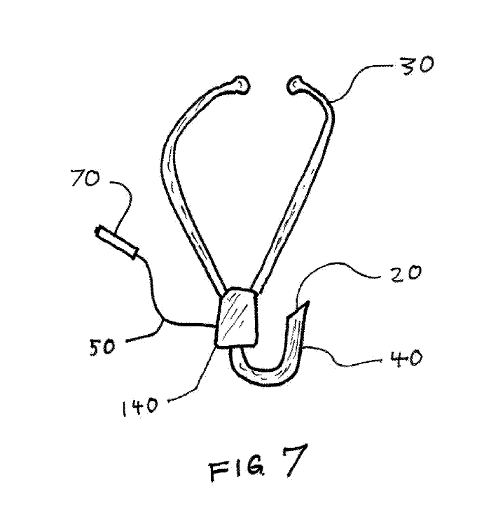

FIG. 7 illustrates an attachment means 30 that is disposed around a neck, like a stethoscope, this is called the stethoscope mounting embodiment 190.

As shown at FIG. 7, the power source 140 may be connected to the two arms of the stethoscope mounting embodiment 190. The light tube 40 may extend from the power source 140, and the cord 50 may extend from the power source 140 to a controller 60.

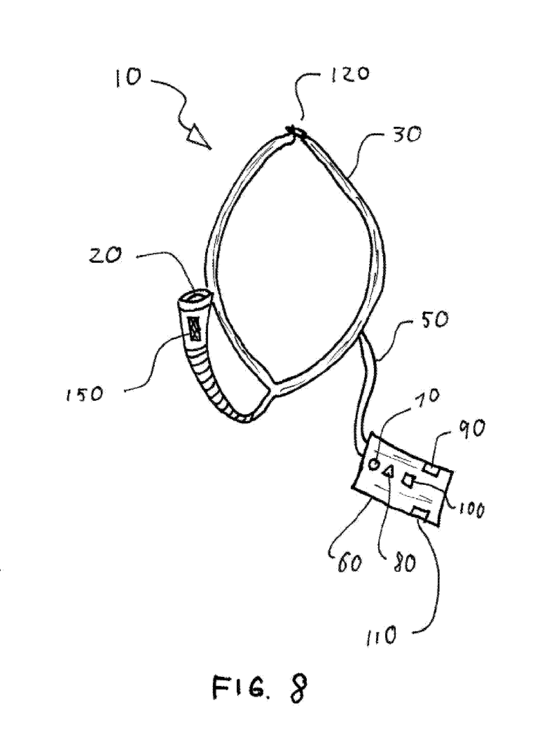

FIG. 8 illustrates an embodiment of the neck attachment 30. It may be bendable and adjustable, or it may be pliable and formless, like a string. The neck attachment 30 may be removed and attached via a clasp 110. The light tube 40 may be bendable so as to direct the light source 20 at different angles.

FIG. 8 also illustrates an embodiment of the face illumination means 10 where the controller 60 has an on-off control 70 for turning the light source off and on, a flickering light control 80 to have the light flicker at desired speeds, a dimmer control 90 to adjust the brightness of the light source, and a color control 100 to change the color of the light rays 130; and to have a sound control 110 to be able to emanate sounds, such as pre-recorded digital sounds, from a speaker 150.

The light tube 40 can be worn so as to be under all clothing, and the light rays 130 shine through an opening of the clothing, such as a typical V-neck type top or shirt.

The novel features cited above, include, but are not limited to those features that allow the face illumination means 10 to (1) be mobile; (2) be able to illuminate the face; (3) be worn under clothing; (4) be adjustable for body frames and shapes; (5) be adjustable brightness settings; (6) have sound settings.

It should be understood, of course, that the foregoing relates to exemplary embodiments of the invention and that modifications may be made without departing from the spirit and scope of the invention as set forth in the following claims

I claim:

1. A face illumination means (10), comprising:
a light tube (40) that secured to at least one of either the body or clothing of a user;
a light source (20) operably disposed in said light tube (40) so that the user can direct light rays (130) that emanate from said light source (20) toward the face of the user.

2. The face illumination means (10) of claim 1, wherein said light tube (40) is flexible and can be placed in a fixed position.

3. The face illumination means (10) of claim 1, further comprising a power source (140) operably connected to said light source (20).

4. The face illumination means (10) of claim 1, further comprising a controller (60) wirelessly connected to said light source (20) to turn said light source on and off.

5. The face illumination means (10) of claim 1, wherein said light tube (40) has a truncated end adjacent to said light source (20) so that the light rays 130 are primarily directed in one direction.

6. The face illumination means (10) of claim 1, wherein said light tube (40) is connected to a power source (140), and said power source (140) can be connected to a garment located near the chest area of the user.

7. The face illumination means (10) of claim 1, wherein a resistor (160) is operably connected to said light source (20) and said power source (140).

8. A face illumination means (10), consisting essentially of:
a light tube (40) that secured to at least one of either the body or clothing of a user;
a light source (20) operably disposed in said light tube (40) so that the user can direct light rays (130) that emanate from said light source (20) toward the face of the user.

9. The face illumination means (10) of claim 8, wherein said light tube (40) is flexible and can be placed in a fixed position.

10. The face illumination means (10) of claim 8, further comprising a power source (140) operably connected to said light source (20).

11. The face illumination means (10) of claim 8, further comprising a controller (60) wirelessly connected to said light source (20) to turn said light source on and off.

12. The face illumination means (10) of claim 8, wherein said light tube (40) has a truncated end adjacent to said light source (20) so that the light rays 130 are primarily directed in one direction.

13. The face illumination means (10) of claim 8, wherein said light tube (40) is connected to a power source (140), and said power source (140) can be connected to a garment located near the chest area of the user.

14. The face illumination means (10) of claim 8, wherein a resistor (160) is operably connected to said light source (20) and said power source (140).
